(19) United States
(12) Patent Application Publication
(10) Pub. No.: US 2023/0222323 A1
(43) Pub. Date: Jul. 13, 2023

(54) METHODS, APPARATUS AND SYSTEMS FOR GRAPH-CONDITIONED AUTOENCODER (GCAE) USING TOPOLOGY-FRIENDLY REPRESENTATIONS

(71) Applicant: InterDigital Patent Holdings, Inc., Wilmington, DE (US)

(72) Inventors: Jiahao PANG, New York, NY (US); Dong TIAN, New York, NY (US)

(21) Appl. No.: 17/925,284

(22) PCT Filed: May 27, 2021
(86) PCT No.: PCT/US2021/034400

§ 371 Date: Nov. 14, 2022

Related U.S. Application Data
(60) Provisional application No. 63/047,446, filed on Jul. 2, 2020.

(51) Int. Cl. G06N 3/045

(52) U.S. Cl. CPC G06N 3/045

(57) ABSTRACT

Method, apparatus and system implemented by a neural network-based decoder (NNBD) are disclosed. In one method, the NNBD may obtain or receive a codeword, as a descriptor of an input data representation. A first neural network module may determine, based on at least the codeword and an initial graph, a preliminary reconstruction of the input data representation. The NNBD may determine, based on at least the preliminary reconstruction and the codeword, a modified graph. The first neural network module may determine, based on at least the codeword and the modified graph, a refined reconstruction of the input data representation. The modified graph may indicate topology information associated with the input data representation.

### CROSS REFERENCE TO RELATED APPLICATION

This application claims the benefit of priority to U.S. Patent Application No. 63/047,446, filed on Jun. 1, 2020 and refiled on Jul. 2, 2020, the contents thereof being incorporated by reference as if fully set forth herein.

### FIELD

Embodiments disclosed herein generally relate to autoencoders for processing and/or compression and reconstruction of data representations and, for example to methods, apparatus and systems for processing, analysis, interpolation, representation and/or understanding of data representations including for example point clouds (PCs), videos, images and audios using learning topology-friendly representations.

### SUMMARY OF EMBODIMENTS

In certain embodiments, unsupervised learning processes, operations, methods and/or functions may be implemented, for example for 3D PCs and/or other implementations using a TearingNet or Graph Conditional AutoEncoder (GCAE), among others. For example, the unsupervised learning operation may include learning of compact representations of 3D PCs, videos, images and/or audios, among others without any labeling information. In this way, representative features may be extracted (e.g., automatically extracted) from 3D PCs and/or other data representations) and may be applied to arbitrary subsequent tasks as auxiliary and/or prior information. Unsupervised learning may be beneficial, because labeling huge amount of data (e.g., PC data or other data) may be time-consuming and/or may be expensive.

In certain embodiments, an autoencoder may be implemented for example to reconstruct a PC based on its compact representation and/or a semantic descriptor. For example, provided a semantic descriptor corresponding to an object, a PC representing the particular object may be recovered. Such a reconstruction may be implemented (e.g., fitted) as a decoder within a popular unsupervised learning framework (e.g., an autoencoder), where the encoder may output a feature descriptor with semantic interpretations.

In certain embodiments, the autoencoder may be implemented for example to consider/use topologies (e.g., via topology inference and/or topology information). When dealing with a PC reconstruction, a graph topology may be implemented to determine/consider (e.g., explicitly determine/consider) the relationship between points. A fully-connected graph topology may be rather inaccurate in representing a PC topology as it does not follow the object surfaces, and may be less effective when dealing with an object with a high genus and/or scenes with multiple objects. The learning of a full graph may be costly and/or may use a large amount of memory and/or computation as there are N² graph parameters (graph weights) to learn, given N points in the reconstructed PC.

In certain embodiments, methods, apparatus, systems and/or procedures may be implemented to learn (e.g., effectively learn) a PC topology representation. The implementation may not only be a benefit in the reconstruction of PCs for complex objects/scenes, but also may be applied to weakly-supervised PC tasks in classification, segmentation and/or recognition, among others.

### BRIEF DESCRIPTION OF THE DRAWINGS

A more detailed understanding may be had from the detailed description below, given by way of example in conjunction with drawings appended hereto. Figures in the description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating a representative autoencoder (e.g., FoldingNet);

FIG. 3 is a diagram illustrating another representative autoencoder (e.g., AtlasNet);

FIG. 4 is a diagram illustrating a further representative autoencoder (e.g., FoldingNet++);

FIG. 5 is a diagram illustrating an additional representative autoencoder (e.g., TearingNet), e.g., with a Tearing Network (T-Net) module;

FIG. 6 is a diagram illustrating a representative T-Net module;

FIGS. 7A, 7B and 7C are diagrams illustrating an example of an input PC and the resulting torn 2D grid and reconstructed PC;

FIG. 8 is a diagram illustrating a representative GCAE autoencoder using a T-Net module for example for PCs;

FIG. 9 is a diagram illustrating a representative GCAE using a T-Net module for example for use in generalized operations (e.g., such as for use with PCs, images, videos, and/or audios, among others);

FIG. 10 is a block diagram illustrating a representative method (e.g., implemented by a neural network-based decoder (NNBD));

FIG. 11 is a block diagram illustrating a representative training method using a multi-stage training operation;

FIG. 12 is a block diagram illustrating another representative method (e.g., implemented by a NNBD;

FIG. 13 is a block diagram illustrating a further representative method (e.g., implemented by a neural network-based autoencoder (NNBAE), for example including an encoding network (E-Net) module and a NNBD;

FIG. 14 is a block diagram illustrating an additional representative method (e.g., implemented by a NNBD);

FIG. 15 is a block diagram illustrating another representative training method (e.g., implemented by a neural network (NN)) using a multi-stage training operation; and

FIG. 16 is a block diagram illustrating a yet further representative method (e.g., implemented by a NNBAE including an E-Net module and a NNBD.

### DETAILED DESCRIPTION

### Example Networks for Implementation of the Embodiments

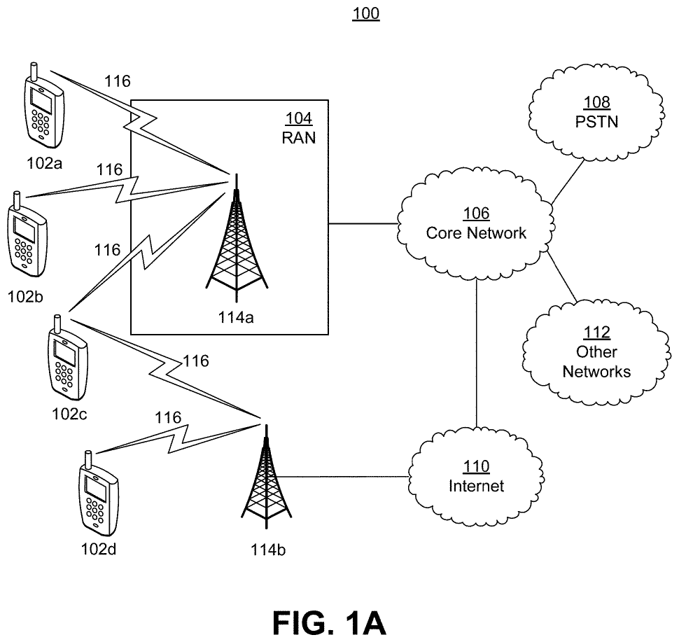

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station. a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B (HNB), a Home eNode B (HeNB), a gNB, a NR Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The processor 118 of the WTRU 102 may operatively communicate with various peripherals 138 including, for example, any of: the one or more accelerometers, the one or more gyroscopes, the USB port, other communication interfaces/ports, the display and/or other visual/audio indicators to implement representative embodiments disclosed herein.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and/or receive wireless signals from, the WTRU 102a.

Each of the eNode Bs 160a, 160b, 160c may be associated with a particular cell (not shown) and may be configured to handle radio resource management decisions, handover decisions, scheduling of users in the UL and/or DL, and the like. As shown in FIG. 1C, the eNode Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode Bs 160a, 160b, 160c. For example, WTRUs 102a, 102b, 102c may implement DC principles to communicate with one or more gNBs 180a, 180b, 180c and one or more eNode Bs 160a, 160b, 160c substantially simultaneously. In the non-standalone configuration, eNode Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Protocol Data Unit (PDU) sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The WTRU 120 may include a decoder portion of an autoencoder or the entire autoencoder to enable at the WTRU 102 various embodiments that are disclosed herein.

### Representative PC Data Format

The Point Cloud (PC) data format is a universal data format across many business domains including autonomous driving, robotics, augmented reality/virtual reality (AR/VR), civil engineering, computer graphics and/or animation/movies. 3D LIDAR sensors may be deployed for self-driving cars. Emerging and affordable LIDAR sensors may be implemented in the numerous products, for example Apple iPad Pro 2020 and/or Intel RealSense LIDAR camera L515. With great advances in sensing technologies, 3D PC data may become more practical than ever and may be an enabler (e.g., an ultimate enabler) in the applications discussed herein.

It is contemplated that PC data may consume a large portion of network traffic (e.g., between or among connected cars over a 5G network, and/or for immersive communications such as VR/AR). PC understanding and communication may lead to more efficient representation formats. For example, raw PC data may need to be properly organized or may be organized and processed for the purposes of 3D world modeling and/or sensing.

PCs may represent sequential updates of the same scene, which may contain one or more moving objects. Such PCs are called dynamic PCs (DPCs), as compared to static PCs (SPCs) that may be captured from a static scene or static objects. DPCs are typically organized into frames, with different frames being captured at different times.

### Representative Use Cases for PC Data

The automotive industry and autonomous car are also domains in which PCs may be used. Autonomous cars are able to “probe” their environment to make good driving decisions based on the immediate vicinity (e.g., a reality of an autonomous car's immediate neighbors/immediate environment). Typical sensors, like LIDARs, may produce DPCs that may be used by a decision engine. These PCs may not or are not intended to be viewed by a human being and the PCs may be small, may not necessarily be colored, and may be dynamic with a high frequency of capture. The PCs may have other attributes like reflectance provided by the LIDAR. Reflectance may be good information on the material of the sensed object and may provide more information regarding a decision (e.g., may help in making the decision).

VR and immersive worlds, which may use PCs are foreseen by many as the future replacement of 2D flat video. For VR and immersive worlds, a viewer may be immersed in an environment (e.g., which is viewable all around the viewer). This is in contrast to standard TV in which the viewer can only view the virtual world in front of the viewer. There are several gradations in the immersivity depending on the freedom of the viewer in the environment. A PC is a format (e.g., a good format candidate) to distribute VR worlds. The PCs for use with VR and immersive worlds may be static or dynamic and may be of average size, for example in a range up to 100 million points at a time (e.g., not more than millions of points at a time).

PCs may be used for various purposes such as culture heritage/buildings in which objects like statues or buildings are scanned in 3D, for example to share the spatial configuration of the object without sending and/or visiting the object and/or to ensure preservation of the knowledge of the object in case the object is destroyed (for instance, a temple being destroyed by an earthquake). Such PCs are typically static, colored and may be large in size (e.g., huge, for example more than a threshold size).

PCs may be used in topography and/or cartography in which 3D representations and/or maps are not limited to a plane and may include a relief (such as an indication of elevations and depressions). Google Maps is a good example of 3D maps. PCs may be a suitable data format for 3D maps and such PCs may be static, colored and/or large (e.g., above a threshold size and/or huge).

World modeling & sensing via PCs may be a technology (e.g., a useful and/or an essential technology), for example to allow machines to gain knowledges about the 3D world around them for the applications discussed herein.

### Representative PC Data Formats

As a popular discrete representation of continuous surfaces in 3D space, PCs are classified into two categories: organized PCs (OPCs), for example collected by camera-like 3D sensors or 3D laser scanners and arranged on a grid, and unorganized PCs (UPCs). UPCs, for example may have a complex structure. UPCs may be scanned from multiple viewpoints and may be subsequently fused together leading to the loss of ordering of indices. OPCs may be easier to process as the underlying grids imply natural spatial connectivity that may reflect the sensing order. The processing on UPCs may be more challenging (e.g., for example due to UPCs being different from 1D speech data and/or 2D images) which are associated with regular lattices. The UPCs may be or are usually sparsely and irregularly scattered in the 3D space, which can make traditional latticed-based algorithms difficult to handle 3D PCs. For example, a convolution operator is well defined on regular lattices and cannot be directly applied to 3D PCs.

In certain examples, discretized 3D PCs may be implemented, for example to transform the PC (e.g., a UPC) to any of: (1) 3D voxels and/or (2) multi-view images, among others, which may cause volume redundancies and/or one or more quantization artifacts. In one example, a deep-neural-network-based supervised process may use pointwise multi-layer perceptron (MLP) followed by pooling (e.g., maximum pooling) to provide/guarantee permutation invariance and to achieve successes on a series of supervised-learning tasks, such as recognition, segmentation, and semantic scene segmentation of 3D PCs. One of skill in the art understands that similar techniques may be applied to many other tasks, such as 3D PC detection, classification, and/or upsampling.

In certain representative embodiments, unsupervised learning processes, operations, methods and/or functions may be implemented, for example for 3D PCs and/or other implementations using a TearingNet or Graph Conditional AutoEncoder (GCAE), among others. For example, the unsupervised learning operation may include learning of compact representations of 3D PCs, videos, images and/or audios, among others without any labeling information. In this way, representative features may be extracted (e.g., automatically extracted) from 3D PCs and/or other data representations) and may be applied to arbitrary subsequent tasks as auxiliary and/or prior information. Unsupervised learning may be beneficial, because labeling huge amount of data (e.g., PC data or other data) may be time-consuming and/or may be expensive.

In certain representative embodiments, an autoencoder may be implemented for example to reconstruct a PC based on its compact representation and/or a semantic descriptor. For example, provided a semantic descriptor corresponding to an object, a PC representing the particular object may be recovered. Such a reconstruction may be implemented (e.g., fitted) as a decoder within a popular unsupervised learning framework (e.g., an autoencoder), where the encoder may output a feature descriptor with semantic interpretations.

In certain representative embodiments, the autoencoder may be implemented for example to consider/use topologies (e.g., via topology inference and/or topology information). When dealing with a PC reconstruction, a graph topology may be implemented to determine/consider (e.g., explicitly determine/consider) the relationship between points. A fully-connected graph topology may be rather inaccurate in representing a PC topology as it does not follow the object surfaces, and may be less effective when dealing with an object with a high genius and/or scenes with multiple objects. The learning of a full graph may be costly and/or may use a large amount of memory and/or computation as there are N² graph parameters (graph weights) to learn, given N points in the reconstructed PC.

In certain representative embodiments, methods, apparatus, systems and/or procedures may be implemented to learn (e.g., effectively learn) a PC topology representation. The implementation may not only be a benefit in the reconstruction of PCs for complex objects/scenes, but also may be applied to weakly-supervised PC tasks in classification, segmentation and/or recognition, among others.

Although many of the examples disclosed herein relate to PC implementations, other implementations are equally possible, such as the use of graph topologies for images, videos, audios, and other data representations that may have topologies associated with them.

### Representative Unsupervised Learning Procedures for PCs

Unsupervised learning for PCs may adopt an encoder-decoder framework. 3D points may be discretized to 3D voxels and 3D convolutions may be used to design and/or implement encoders and/or decoders. The discretization may lead to unavoidable discretization errors and the use of 3D convolutions may be expensive. In certain examples, where PointNet is used as the encoder and fully-connected layers are used as the decoder, 3D points may be handled (e.g., directly handled) and may be effective. In certain representative embodiments, methods, apparatus, systems and/or procedures may be implemented for PC reconstructions that may use graph topologies for example to improve PC reconstruction without using/requiring a huge amount of training parameters.

### Representative Procedures Using Autoencoders Such as FoldingNet and AtlasNet for PCs

The FoldingNet decoder is an efficient decoder design/implementation that enables reduced training parameters compared to a fully-connected network implementation/design. A FoldingNet decoder takes a semantic descriptor as input (e.g., from an encoder), and learns a projection function that maps a set of 2D sample points into 3D space. The set of 2D points can be sampled regularly over a 2D grid. The operations are efficient (e.g., very efficient) for single objects with a simple topology, but are not good at handling objects with a complex topology or a scene with multiple objects.

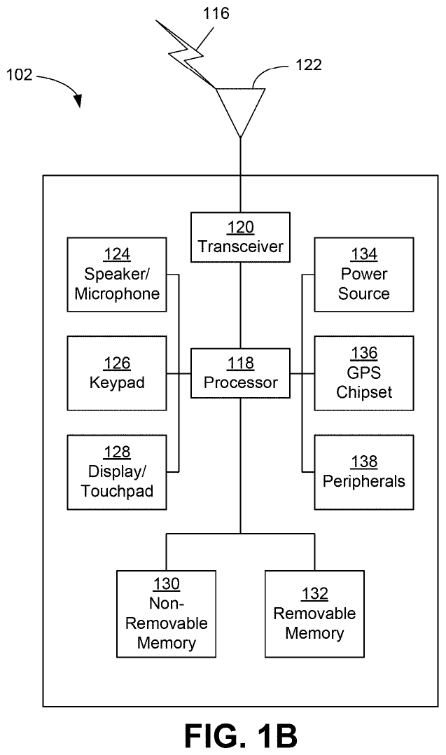

FIG. 2 is a diagram illustrating a high level structure/architecture of a representative autoencoder (e.g., a FoldingNet architecture) which includes an encoder and a decoder. The encoder and the decoder both include a neural network which generates, and stores learned network node parameters/weights.

Referring to FIG. 2, the representative autoencoder 200 may include an encoder 220 and a decoder 260. The encoder 220 may have, as an input, a set of points 210 (e.g., a set of 3D points and/or a point cloud) and may have, as an output a descriptor vector 230. The decoder 260 may have, as an input, the descriptor vector 230 and may have, as an output a reconstructed point cloud 270. The decoder 260 may include a neural network (NN) and/or folding module (FM) 250. An input to the NN/FM 250 may be composed of and/or may include the descriptor vector 230 and a point set pre-sampled on a grid 240 (e.g., a 2D grid).

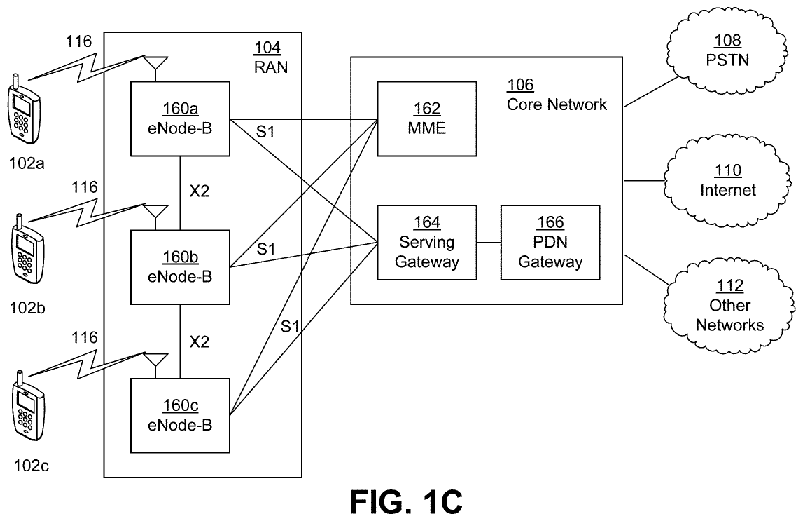

FIG. 3 is a diagram illustrating another representative autoencoder structure/architecture (e.g., an AtlasNet type architecture).

Referring to FIG. 3, the representative autoencoder 300 may include an encoder 320 and a decoder 360. The encoder 320 may have, as an input, a set of points 310 (e.g., a set of 3D points and/or a point cloud) and may have, as an output a descriptor vector 330. The decoder 360 may have, as an input, the descriptor vector 330 and may have, as an output, a reconstructed point cloud 370. The decoder 360 may include a plurality of NNs/FMs 350-1, 350-2 . . . 350-K, for example in parallel. An input to each NN/FM may be composed of and/or may include the descriptor vector 330 and a point set pre-sampled on an N dimensional grid 340 (e.g., each NN/FM may include a 2D grid 340-1, 340-2 or 340-K). In certain examples, the grid 340-1, 340-2 . . . 340-K may be the same. In other examples, each grid 340 may be different.

The representative autoencoder 300 (e.g., AtlasNet type autoencoder and/or AtlasNet2 type autoencoder) provides a naive way to handle complex topology by including in the decoder 360 multiple K FMs 350. In the AtlasNet type encoder, each FM 350 maps an atlas patch (2D grid) to an object part. When the patch number K is changed, the autoencoder/NNs 300 may have to be re-trained. With an increase in the number of FMs 350 (e.g., to K FMs), the network size and memory required may be linearly scaled up to store the network parameters/data. Setting a patch number K in advance may make it difficult or impossible to adapt the network to cover PCs with a good range of complexities. The reconstruction performance may be sensitive to the patch number (e.g., the visual quality may improve with the number of patches; but more artifacts may appear with more parameterizations).

In certain representative embodiments, procedures may be implemented to use topology information (e.g., topology graphs) to improve the folding procedures/operations.

Representative Autoencoder (e.g., FoldingNet++ with Graph Topology Inference) for PCs

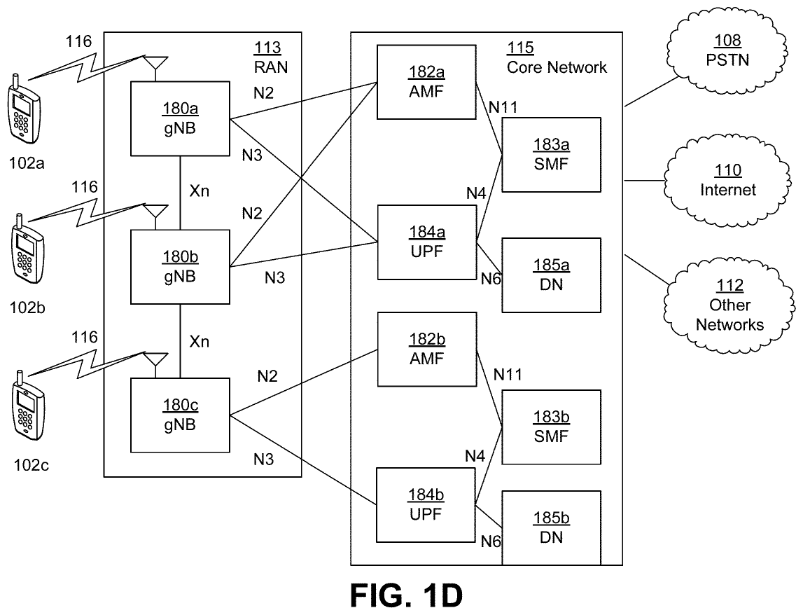

FIG. 4 is a diagram illustrating a further representative autoencoder (e.g., FoldingNet++).

Referring to FIG. 4, the representative autoencoder 400 (e.g., FoldingNet++ type autoencoder) with graph topology inference may be implemented to enable a representation of a topology (e.g., a point cloud PC topology). The autoencoder 400 may include an encoder 420 and a decoder 460. The encoder 420 may have, as an input, a set of points 410 (e.g., a set of 3D points and/or a point cloud) and may have, as an output a descriptor vector 430. The decoder 460 may have, as an input, the descriptor vector 430 and may have, as outputs, a reconstructed point cloud 470 and/or a fully connected graph 455 associated with the point cloud 410. The decoder 460 may include a plurality of modules including a NN/FM 450 and/or a Graph Inference module 454. Inputs to the NN/FM 450 may be composed of and/or may include the descriptor vector 430 and a point set pre-sampled on a grid 440. Inputs to the Graph Inference module 454 may be an adjacency matrix 452 (e.g., a full adjacency matrix) describing a grid-like graph topology and/or the descriptor vector 430. The output of the Graph Interference module 454 may be another adjacency matrix/connected graph 455 (e.g., a full adjacency matrix of a learned fully-connected graph). The adjacency matrix/connected graph 455 and/or the reconstructed point cloud 470 may be inputs to a Graph Filtering module 480. The Graph filter module 480 may filter the reconstructed point cloud 470 with graph 455 to generate a final (e.g., refined) reconstructed point cloud 490.

It is contemplated that the FM, Graph Inference module and/or the Graph filtering module may be or may include one or more NNs.

A NN may be designed/implemented to capture the graph topology. For example, a fully-connected graph 455 may be deployed in which any point pair may be connected by a graph edge. However, a fully-connected graph topology is not a good approximation of a PC topology (e.g., relative to a locally-connected graph topology), because it allows connections between distant point pairs and hence does not follow 2D manifolds represented by PCs.

Relative to the FoldingNet autoencoder structure, the FoldingNet++ autoencoder may include a Graph Inference module 454 and a Graph Filtering module 480. It is contemplated that the input to the Graph Inference module 480 may be a full adjacency matrix describing a grid-like graph topology, and the output of the Graph Interference module 454 is another full adjacency matrix of a learned fully-connected graph. The Graph Filtering module 454 may modify the coarse reconstruction from the Folding Module (e.g., a deforming module), and output a final reconstruction of a point cloud (PC) 410.

Relative to the AtlasNet autoencoder structure, the Graph Inference module 454 of FoldingNet++ autoencoder may not be scaled up with complex topologies and may still use/require a large memory and large computations due to the huge number of graph parameters (e.g., graph weights). Given the number of points in a reconstructed PC is N, the number of graph parameters is N².

In certain representative embodiments, methods, apparatus, systems, operations and/or procedures may be implemented to enable an autoencoder architecture (e.g., having a TearingNet module) to learn a topology-friendly representation (for example for PCs, images, video and/or audio, among other data representations having a topology).

In certain representative embodiments, methods, apparatus, systems, operations and/or procedures may be implemented to provide a topology of a data representation. For example, in one representative method, an explicit representation of a PC topology may be implemented by tearing a 2D grid into multiple patches. Different from the patches in AtlasNet autoencoder that are totally independent from each other, the patches in these embodiments may be included in the same 2D plane and the same coordinate system with or without overlapping.

For a FoldingNet autoencoder, a point set sampled from a 2D grid is provided as an input to a folding process to reconstruct a PC from a semantic descriptor, which is computationally efficient relative to fully-connected networks. For the initial samples from the 2D grid in the FoldingNet autoencoder, the initial samples represent a simplest topology, with genus 0. It is observed that the FoldingNet autoencoder is unable to properly handle an object with complex topology or a scene with multiple objects. It is contemplated that the oversimplified topology of the 2D grid may be a reason for the inability to handle such a complex topology.

A graph topology may be used to approximate a PC topology, but two weak points have been observed, namely that: (1) a mismatch between fully-connected graph topologies and PC topologies exist; and (2) the graph filtering procedure can fail (e.g., often fail) to correct points erroneously mapped outside the surfaces.

In certain representative embodiments, a TearingNet autoencoder (e.g., having a Tearing module and/or topology evolving grid representation) may be implemented and may align a 2D topology (e.g., an n−1 dimensional grid topology) with the 3D topology (e.g., an n dimensional PC topology or other n dimensional topologies associated with a data representation). For example, a regular 2D grid may be torn into multiple patches to provide a 2D grid with patches (e.g., a topology-friendly 2D grid and/or the topology evolving grid representation).

In certain representative embodiments, the TearingNet autoencoder may be implemented and may promote a locally-connected graph as a better approximation of the 3D PC topology.

In certain representative embodiments, the TearingNet autoencoder may be implemented and may set/use the torn 2D grid with modified topology as an input to a Folding module such that the learned 2D topology may be directly counted/considered in the 3D PC reconstruction. For example, a regular 2D grid may be used initially as an input to the Folding module and, subsequently, a modified and/or evolved 2D grid may be used as the next input to the Folding module.

In certain representative embodiments, a T-Net module may be implemented and may generate a modified/evolved grid that may represent (e.g., explicitly represent) a topology (e.g., a PC topology) by tearing a regular grid (e.g., 2D grid) into a torn grid (e.g., 2D grid, for example an evolved 2D grid having one or multiple patches), which may serve as the input of a subsequent Folding Network (F-Net) module or deforming module. For example, based on the torn 2D grid, a locally-connected graph may be constructed which may follow the 3D topology (e.g., the 3D PC topology or other 3D topology). The constructed locally-connected graph may be used to refine the output PC.

In certain representative embodiments, an autoencoder (e.g., TearingNet) may be implemented and may enable PC reconstruction for PCs with diverse topological structures (e.g., PCs with objects with different genera and/or scenes with multiple objects). The autoencoder may generate representations (e.g., codewords) that reflect (e.g., well reflect) the underlying topology of the input PCs.

In certain representative embodiments, a multi-stage (e.g., two or more stage) training procedure may be implemented, for example to solve point-collapse which may be caused by the use of, for example, Chamfer distances.

In certain representative embodiments, a TearingNet autoencoder/Graph-Conditioned autoencoder (GCAE) with multiple iterations (e.g., more than two iterations) may be implemented to handle PC scenes and/or other scenes (e.g., video and/or data representations, among others) with complex topologies.

### Representative TearingNet Autoencoder

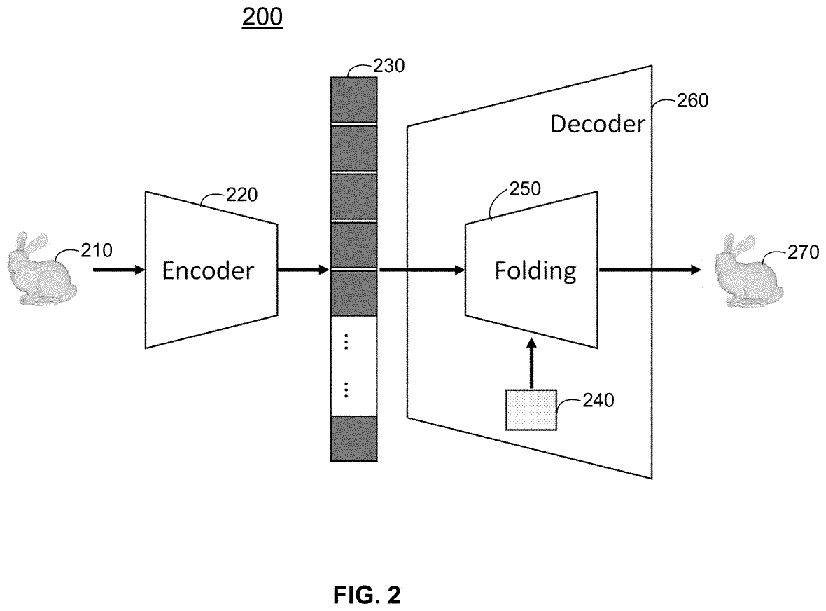

FIG. 5 is a diagram illustrating an additional autoencoder (e.g., a TearingNet autoencoder) and an unsupervised training framework/procedure used with the TearingNet autoencoder.

Referring to FIG. 5, the TearingNet autoencoder 500 may include an encoder 520 and a decoder 560. The encoder 520 may have, as an input, a set of points 510 (e.g., a set of 3D points and/or a point cloud) and may have, as an output a descriptor vector 530. The decoder 560 may have, as an input, the description vector 530 and may have, as outputs, a reconstructed point cloud 570 and/or a locally connected graph 558 associated with the point cloud 510. The decoder 560 may include a plurality of modules including one or more NNs and/or a plurality of FMs 550-1 and 550-2 and/or Tearing modules 556. Inputs to the first NN/FM 550-1 may be composed of and/or may include the descriptor vector 530 and a point set pre-sampled on a grid 540. Inputs to the Tearing module 556 may include the point set pre-sampled on the grid 540, the descriptor vector 530, and/or the output of the first NN/FM 550-1. The output of the Tearing module 556 may be combined with and/or summed with the point set pre-sampled on the grid 540 to generate the locally connected graph 558. Inputs to the second NN/FM 550-2 may be composed of and/or may include the descriptor vector 530 and/or the locally connected graph 558. The NN/FMs 550-1 and 550-2 of the decoder 560 may share the same neural network architecture and the same learned NN parameters. The output to the second NN/FM 550-2 may include the reconstructed point cloud 570. The locally connected graph 558 and/or the reconstructed point cloud 570 may be inputs to a Graph Filtering module 580. The Graph filter module 580 may filter the reconstructed point cloud 570 with graph 558 to generate a final (e.g., refined) reconstructed point cloud 590.

It is contemplated that the FMs, the Tearing module and/or the Graph filtering module may be or may include one or more NNs.

For example, the encoder 520 may be a PointNet like encoder (e.g., used in FoldingNet or FoldingNet++ encoders) or any other neural network encoder that can output a descriptor vector 530. The decoder 560 may include one or a plurality of F-Net/deforming modules 550 (e.g., one or more F-Net/deforming neural networks), one or more T-Net modules 556 (e.g., one or more T-Net neural networks), and a 2D grid 540. The input to the first F-Net module 550-1 may include a descriptor vector 530 and the initial 2-D grid 540. The input to the T-Net module 556 may include the descriptor vector 530, the initial 2-D grid 540 and the output of the first F-Net module 550-1. The output of the T-Net module 556 may include a torn 2D grid 558 (e.g., an evolved 2D grid and/or a 2D grid with patches representative of the topology of the data representation that generates the descriptor vector via the encoder). A subsequent input to the first F-Net module 550-1 or an input to another F-Net module 550-2 with the same neural network architecture and the same learned NN parameters/weights may include the descriptor vector 540 and the torn 2D grid output from the first T-Net module 558. The output of the T-Net module 556 may include a locally-connected graph 558.

Similar to the F-Net module 550, a deforming module may deform the input to reconstruct the input data representation such that the F-Net module and deforming module may be used interchangeably.

The output of the last F-Net module 550-2 and the last evolved 2D grid 558 may be the input to a graph filtering module 580. The output of the graph filtering module 580 may be the final reconstructed PC 590.

Although two F-Net modules and one T-Net module are shown in FIG. 5, any number of F-Net modules (e.g., N F-Net modules) may be implemented in the decoder and a corresponding number of T-Net modules (e.g., N or N−1 T-Net modules may also be implemented. In certain embodiments a single F-Net module and a single T-Net module may be implemented in the decoder with an iterative process that generates a series of evolving torn 2D grids. Each torn 2D grid may be used as an input to the F-Net module for one iteration of the reconstructed PC.

Comparing the TearingNet autoencoder to the FoldingNet and FoldingNet++ autoencoders as illustrated in FIGS. 2 and 4, respectively, a few modules can be implemented/designed in a similarly manner, including the encoder (E-Net) module, the folding (F-Net) module, 2D point set as input to the first execution of the F-Net module, and a Graph filtering (G-Filter) module.

In certain implementations, the E-Net module may be based on PointNet, that takes a PC xₖ=(xₖ, xₖ, zₖ) as input and outputs a descriptor vector.

The descriptor vector may be sent to the decoder, that includes the F-Net module and the T-Net module. Both the F-Net module and the T-Net module may be invoked for each 2D point with an index k or i.

For a first execution of the F-Net module, the input may be set as a concatenation of the descriptor vector f and a 2D point i from a 2D grid uᵢ⁽⁰⁾=(uᵢ⁽⁰⁾, vᵢ⁽⁰⁾) using a predefined sampling operation, e.g., uniformly sampled with equal spacing. The F-Net module may output a first reconstruction of the PC, xᵢ⁽¹⁾=(xᵢ⁽¹⁾, yᵢ⁽¹⁾, zᵢ⁽¹⁾). Next, the T-Net module may be invoked. The input to the T-Net module may include the descriptor vector f, the 2D point i sampled from the 2D grid uᵢ⁽⁰⁾=(uᵢ⁽⁰⁾, vᵢ⁽⁰⁾), and the first reconstruction of the PC xᵢ⁽¹⁾=(xᵢ⁽¹⁾, yᵢ⁽¹⁾, zᵢ⁽¹⁾). For example, the input may be a concatenated vector from f, uᵢ⁽⁰⁾=(uᵢ⁽⁰⁾, vᵢ⁽⁰⁾), xᵢ⁽¹⁾=(xᵢ⁽¹⁾, yᵢ⁽¹⁾, zᵢ⁽¹⁾), and a 6-dim gradient vector ∂xᵢ⁽¹⁾/∂uᵢ⁽⁰⁾, as set forth in Equation 1 as follows:

$$\frac{\partial {x}_{i}^{( 1 )}}{\partial {u}_{i}^{( 0 )}} = \frac{\partial ( {x}_{i}^{( 1 )} , {y}_{i}^{( 1 )} , {z}_{i}^{( 1 )} )}{\partial ( {u}_{i}^{( 0 )} , {v}_{i}^{( 0 )} )} . \qquad ( 1 )$$

The T-Net module may output (e.g., finally output) a modification on the 2D point set, that is added to/on top of uᵢ⁽⁰⁾=(uᵢ⁽⁰⁾, vᵢ⁽⁰⁾), and can lead to a modified 2D point as set forth in Equation 2, as follows:

uᵢ⁽¹⁾=(uᵢ⁽¹⁾,vᵢ⁽¹⁾) (2)

A second execution of the F-Net module may be invoked. It is contemplated that the F-Net module in this operation/execution and from the previous operation/execution may use/share a common F-Net module. For this operation, the input may be set as a concatenation of the descriptor vector f and the modified 2D grid uᵢ⁽¹⁾=(uᵢ⁽¹⁾, vᵢ⁽¹⁾) (e.g., a set of modified 2D points or modified 2D samples). The F-Net module may output a second reconstruction of PC xᵢ⁽²⁾=(xᵢ⁽²⁾, yᵢ⁽²⁾, zᵢ⁽²⁾).

Similar to the F-Net module, the T-Net module may be implemented via a neural network which parameters are achieved via training based on one or more PC datasets (e.g., training datasets).

From the modified 2D samples uᵢ⁽¹⁾, a nearest neighbor graph G (e.g., a locally-connected graph) may be constructed. A graph filtering may be performed on the second reconstructed PC xᵢ⁽²⁾=(xᵢ⁽²⁾, yᵢ⁽²⁾, zᵢ⁽²⁾) using a graph filter that may be based on the nearest neighbor graph G. The graph filtering may output the final PC reconstruction \hat{x}ᵢ=(\hat{x}ᵢ, ŷᵢ, \hat{z}ᵢ).

To train the TearingNet autoencoder (e.g., the TearingNet framework), in certain implementations, a loss function, as set forth in Equation 3, may be defined/uses based on a Chamfer distance between the input PC x={xₖ} with M points and the output PC \hat{X}={\hat{x}ᵢ} with N points:

$$d ( X , \hat{X} ) = max \{ \frac{1}{M} {\sum }_{x ∈ X} {min}_{\hat{x} ∈ \hat{X}} {‖ x - \hat{x} ‖}_{2} , \frac{1}{N} {\sum }_{\hat{x} ∈ \hat{X}} {min}_{x ∈ X} {‖ x - \hat{x} ‖}_{2} \} . \qquad ( 2 )$$

Although the loss function is illustrated to be based on Chamfer distance, other loss functions based on other distance-related measures (e.g., Hausdorff distance or Earth Mover's distance, among others) are possible.

### Representative T-Net Module

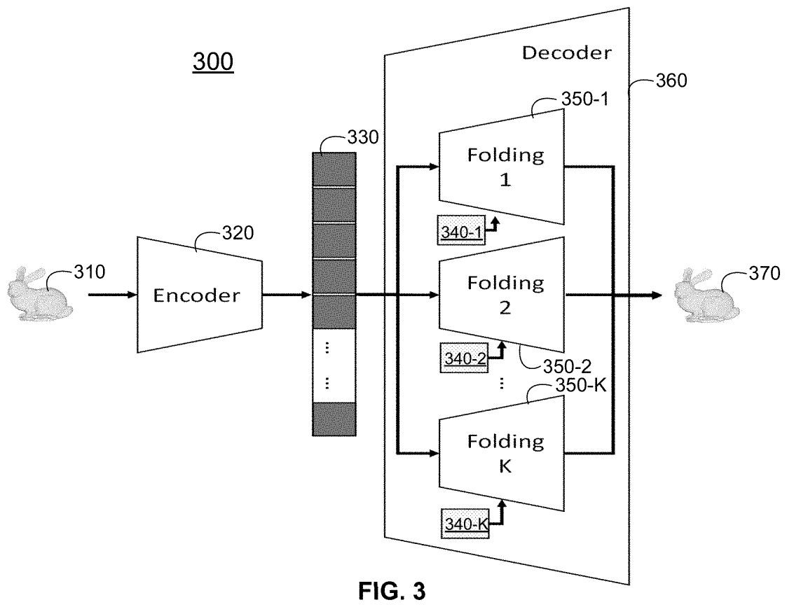

FIG. 6 is a diagram of a representative Tearing (T-Net) module.

Referring to FIG. 6, the representative Tearing/T-Net module 600 may include plural sets (e.g., two or more sets) of N×N Convolutional Neural Networks (CNNs) 610 and 620 (e.g., 3×3 CNNs) and/or one or more Multi-layer Perceptrons (MLPs) (e.g., fully connected neural networks), among other types of neural networks.

The codeword f (e.g., descriptor vector 530) may be replicated N times in a N×512 matrix 630 (e.g., if the codeword f is 512-dim, although other dimensions are possible such as 128, 256, 1024, 2048 or 4096, among others). The replicated matrix 630 from f may be concatenated to generate a first concatenated matrix 640 (e.g., a N×523 matrix that may include an N×2 matrix 645 from the grid/points 540 (e.g., 2D grid/points u), an N×3 matrix from 3D points x, and an N×6 matrix from the gradient 650 (e.g., the gradient ∂x/∂u). The 3D points x may be the output from the F-Net module 550-1. Each row of the first concatenated matrix 640 (e.g., the N×523 matrix) may be passed through a first neural network 610 (e.g., a shared 3×3 CNN or MLP) of the Tearing/T-Net module 556. The first neural network 610 (e.g., the first CNN) may include or be composed of N layers (e.g., 3 layers). The first concatenated matrix 640 may be input to the first CNN (not shown) of the series of CNNs (not shown). The first series of CNNs may have output dimensions of 256, 128 and 64 for the first, second and third layers, respectively).

An input matrix for a second neural network 620 (e.g., a second CNN) of the series of neural networks may be formed, generated and/or constructed similarly to the previous operation, and may include a second concatenated matrix 660 which includes the first concatenated matrix 645 and the 64-dimension feature output from previous operation (e.g., a N×64 matrix 655) output from the first CNN 610. The second concatenated matrix 660, (which may be N×587 matrix) may be the input matrix N×587 for the second neural network 620 (e.g., the second CNN or MLP in the series). Each row of the input matrix may pass through the second CNN 620 (e.g., a shared 3×3 CNN or MLP). The second series of CNNs may include or be composed of 3 layers (not shown) with output dimensions of 256, 128 and 2 for the first, second and third layers, respectively. The final output matrix N×2 665 of the Tearing/T-Net module 556 may represent a modification/evolvement of the 2D grid 540 (e.g., 2D grid x).

Relative to the complexity of FoldingNet++, for the same size of the 2D grid with N points, the input and output dimension for FoldingNet++ are N+512 and N, while the input and output dimension for TearingNet are 11+512 and 2. Comparing the complexity of AtlasNet to TearingNet, in AtlasNet, the number of F-Net modules are equal to a preset size of the Atlas, which should or has to be large for practical scenes. TearingNet may only need/use one F-Net module and one T-Net module in total in the decoder, regardless of the scene complexity.

The T-Net module may use a neural network, as a mapping function, like the following,

u⁽¹⁾=T(u⁽⁰⁾,f, . . . ). (4)

The descriptor f may drive the T-Net module to tear the 2D grid/points into patches. For example, for a PC with 3 objects, the 2D grid/points may be or is torn into three patches and the T-Net module may generate the modified/evolved 2D grid/points.

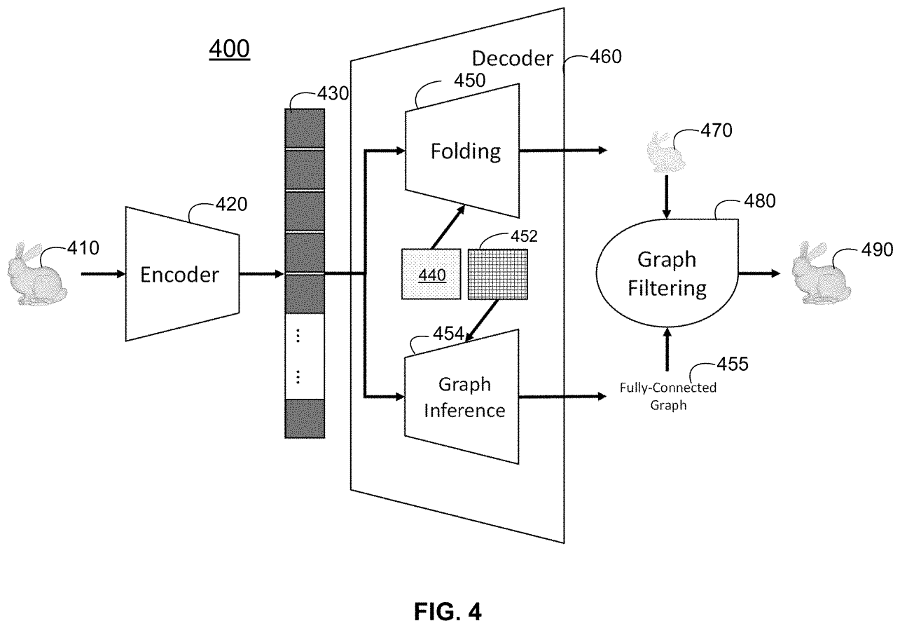

FIG. 7A is a diagram illustrating an example of an input PC. FIG. 7B is a diagram illustrating an example of a torn/evolved 2D grid associated with the input PC of FIG. 7A. FIG. 7C is a diagram illustrating an example of a reconstructed PC associated with the input PC of FIG. 7A. The torn 2D grid of FIG. 7B may include patches A1, B1, C1 and D1. The tearing/T-Net module 556 may generate the torn/evolved 2D grid. The input PC includes four objects (e.g., three vehicles (object A, C and D) and a cyclist (object B) and the torn 2D grid includes tears that generally correspond to the areas around each object in the input PC.

### Representative Sculpture Training Procedure

In certain representative embodiments, a training procedure (e.g., a two-stage sculpture training procedure may be implemented, for example using a distance measure (e.g., Chamfer distance, earth mover's distance or other distance metric) to train the TearingNet. Chamfer distance is less complex than earth mover's distance, but have issues of point-collapse. The loss function using Chamfer distance of Equation 3 may be rewritten as set forth in Equations 5 and 6, as follows.

$$\begin{matrix}d ( X , \hat{X} ) = max \{ \frac{1}{M} {\sum }_{x ∈ X} {min}_{\hat{x} ∈ \hat{X}} {‖ x - \hat{x} ‖}_{2} , \frac{1}{N} {\sum }_{\hat{x} ∈ \hat{X}} {min}_{x ∈ X} {‖ x - \hat{x} ‖}_{2} \} & ( 5 ) \\ {=}^{Δ} max \{ {d}_{\hat{x} ⊇ x} , {d}_{\hat{x} ⊆ x} \} , & ( 6 )\end{matrix}$$

where the two distance items in max(., .) are referenced as d_{\hat{x}⊇x} and d_{\hat{x}⊆x}, respectively. The two distance items may contribute in two different ways for the PC assessment. It is contemplated that X, as the input PC, is fixed; and \hat{X}, as a reconstruction under searching, is to be evaluated. d_{\hat{x}⊇x} is referenced as the superset-distance and may be alleviated as long as the reconstructed PC \hat{X} is a superset of the input PC X. For example, when the reconstruction is exactly a superset of the input, the superset-distance may be equal to zero, and any remaining points outside of x would not penalize the superset-distance. d_{\hat{x}⊂x} is referenced as the subset-distance and may be relieved as long as the reconstructed PC x is a subset of the input PC X. For example, when the reconstruction is exactly a subset of the input, subset-distance would be equal to zero.

To begin with the training, reconstructed points spatter around the space, as the network parameters are randomly initialized. Given a sufficient number of points and a dataset with ample topological structures, subset-distance may likely to be larger than and more dominant than the superset-distance. This can be interpreted/determined by treating a reconstruction as learning a conditional occurrence probability at each spatial location given a latent codeword. When shapes (e.g., PCs) used for training fluctuate drastically, the learned distribution may be more uniformly spread across space. Hence, more chances exist for reconstructed points to fall outside of the ground truth input PC. Subset-distance may be penalized more than the superset-distance, which may make subset-distance dominant during training.

The ill-balanced Chamfer distance with dominating subset-distance may lead to point collapse, even at the beginning of training. Consider that there exists a single shared point among all objects in a dataset, a trivial solution to minimize the subset-distance (to be 0) is to collapse all points to the shared point. Even if there are no intersections between object shapes, points may still collapse to a single point-estimator close to the surface for a trivial solution to minimize the subset-distance.

A sculpture training procedure/strategy may be implemented and may include at least two training stages. In a first stage, the superset distance (e.g., only the superset-distance) may be used as the training loss to rough out a preliminary form. In a second stage, the Chamfer distance including the subset-distance may be used to polish (e.g., refine) the reconstruction. The sculpture training procedure to train the TearingNet may resemble a subtractive sculpture procedure/process. After a rough form is constructed/generated from the first stage, the T-Net module may carve (e.g., specifically may carve) unwanted material for the final statue in the second stage, and may generate the torn 2D grid (e.g., including the patches, as shown in FIG. 7B). The two stage sculpture training procedure may include, for example:
(1) training the F-Net module under the FoldingNet architecture with the superset-distance being the loss function (in certain embodiments, the learning rate may be set to r₁=10⁻³); and
(2) loading the pre-trained F-Net module into the TearingNet architecture, and continue to train the F-Net module and the T-Net module with Chamfer distance as the loss function, (e.g., both the superset-distance and the subset-distance may be counted and the learning rate may be adjusted to be smaller, e.g., r₂=10⁻³r₁=10⁻⁶).

### Representative Iterative TearingNet Architecture/Implementation

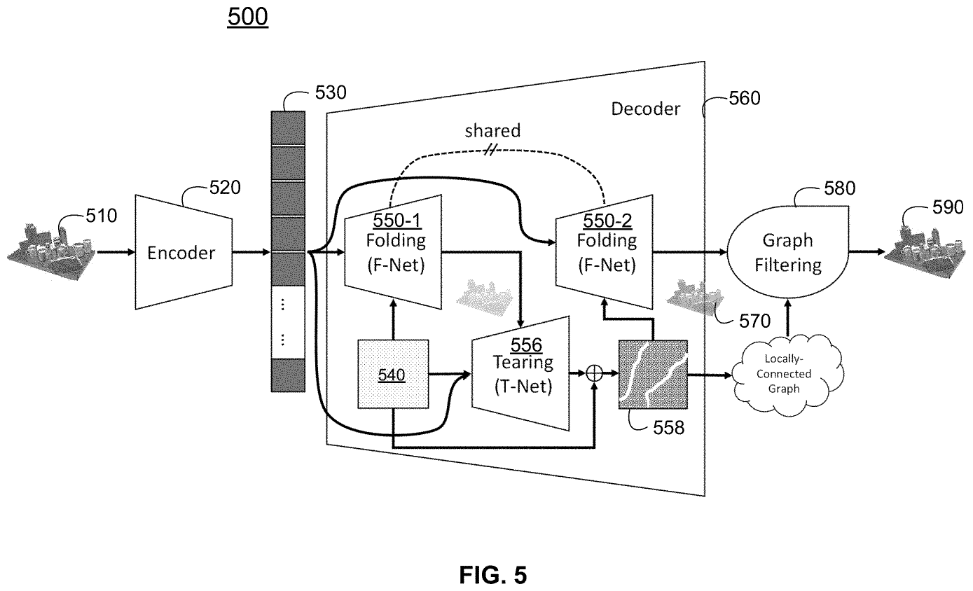

FIG. 8 is a diagram illustrating a representative Iterative TearingNet architecture supporting multiple iterations. Referring to FIG. 8, the Iterative TearingNet 800 may include the same or similar modules to those of FIG. 6. For example, the Iterative TearingNet 800 may include an encoder 820 and a decoder 860 that may include a T-Net module 856 and a F-Net module 850 and may use an evolving 2D grid 858. With the loop structure, the F-Net module 850 and the T-Net module 856 may be allowed to run any number of iterations (e.g., several iterations). In each iteration, the F-Net module 850 may take the 2D grid 858 which was output from the T-Net module 856 from a previous iteration, as one input to the F-Net module 850, the T-Net module 856 may take the 3D points (and gradients) which was output from the F-Net module 850 from the current iteration, as input to the T-Net module 856. The TearingNet 800 with multiple iterations may be used to handle challenging (e.g., even more challenging) object/scene topologies.

The input to the encoder 820 may be or may include, for example, a point cloud 810.

The encoder 820 may output a descriptor vector 830. In a first operation/step of a first iteration of the iterative TearingNet 800, shown in FIG. 8 as first step dashed lines, the F-Net module 850 may receive inputs from the descriptor vector 830 and the initial 2D grid 858-1. The initial 2D-grid 858-1 may be output as a locally connected graph. In a second operation/step of the first iteration of the iterative TearingNet 800, shown in FIG. 8 as second step dashed lines, the T-Net 856 may receive as inputs, the output of the F-Net 850 from the first operation, the descriptor vector 830, and the initial 2D grid 858-1. The output of the F-Net 850 in the second operation/step may be a reconstructed point cloud 870. In a third operation/step of the first iteration of the iterative TearingNet 800, shown in FIG. 8 as a third step dashed line, the T-Net 856 may output a first modified 2D grid 858-2.

In a first operation/step of a second iteration of the iterative TearingNet 800, shown in FIG. 8 as first step dashed lines, the F-Net module 850 may receive inputs from the descriptor vector 830 and the first modified 2D grid 858-2. The first modified 2D grid 858-2 may be output as the locally connected graph. In a second operation/step of the second iteration of the iterative TearingNet 800, shown in FIG. 8 as second step dashed lines, the T-Net 856 may receive as inputs, the output of the F-Net 850 from the first operation in the second iteration, the descriptor vector 830, and the first modified 2D grid 858-2. The output of the F-Net 850 in the second operation/step of the second iteration may be a first modified reconstructed point cloud 870. In a third operation/step of the second iteration of the iterative TearingNet 800, shown in FIG. 8 as a third step dashed line, the T-Net 856 may output a second modified 2D grid 858-3.

For each iteration, the output of the 2D grid/modified 2D grid (e.g., the current locally connected graph 858-1, 858-2 or 858-3 and the reconstructed or modified reconstructed point cloud 870 may be input to a graph filtering module 880 to provide graph filtering and to generate a final reconstructed point cloud.

Although two iterations are shown in FIG. 8, any number of iteration of the TearingNet 800 are possible.

In certain representative embodiments, the initial point set may be regularly sampled over a 2D grid (e.g., the first/initial 2D grid 8581. A sphere or cubic surface may be selected to replace the 2D grid and/or the 2D grid may be replaced with a N-dimensional grid. In certain embodiments, another sampling operation may replace the uniform sampling on the surface.

The TearingNet 800 may provide an unsupervised learning framework. Procedures for reconstruction of a data representation such a PC are disclosed herein and may include an initial learning operation in which neural network weights/parameters are establish for the E-Net module, the T-Net module and the F-Net module in an end-to-end operation. After the initial learning operation, the encoder 820 and the decoder 860 of the autoencoder 800 (e.g., with the neural network weights/parameters established) may be operated separately. It is contemplated that the descriptor f may serve as a topology-aware representation. The TearingNet 800 may push the encoder 820 to output a descriptor in a feature space that is more friendly to object/scene topologies. Such a topology-aware representation may benefit many tasks like object classification, segmentation, detection, scene completion by alleviating the need for labeled data. The TearingNet may be useful in PC compression, as it provides a different way to reconstruct PCs.

In certain representative embodiments, a neural network may be implemented with a T-Net module, for example to learn a topology-friendly representation associated with a data representation such as a PC, a video, an image and/or an audio, among others. For example, by using an evolving 2D grid/points, the neural network may deal with objects/scenes with complex topology. The neural network may reside in the decoder part of an end-to-end autoencoder for unsupervised learning. In other representative embodiments, a sculpture training procedure/strategy may, for example enable better tuned neural network weights/parameters.

### Representative Design/Architecture of a Merged T-Net and Second F-Net Module

In certain embodiments, the functionality associated with the first iteration of the T-Net module and the second iteration of F-Net module may be implemented in a unified architecture/module (e.g., a combined TearingFolding Network (TF-Net) architecture/module). The input to the TF-Net module may be arranged in the same way as the input to the F-Net module, e.g., a latent codeword and a 2D point set from a 2D grid. The output of the TF-Net module may be a modification of 3D points. For final PC reconstruction, the 3D modification may be applied to the output from the first F-Net module. The TF-Net module may be viewed as a direct tearing in the 3D space instead of a tearing of the 2D grid. For example, a benefit of the TF-Net module implementation may be to simplify the overall architecture compared to that of FIG. 8.

### Representative GCAE

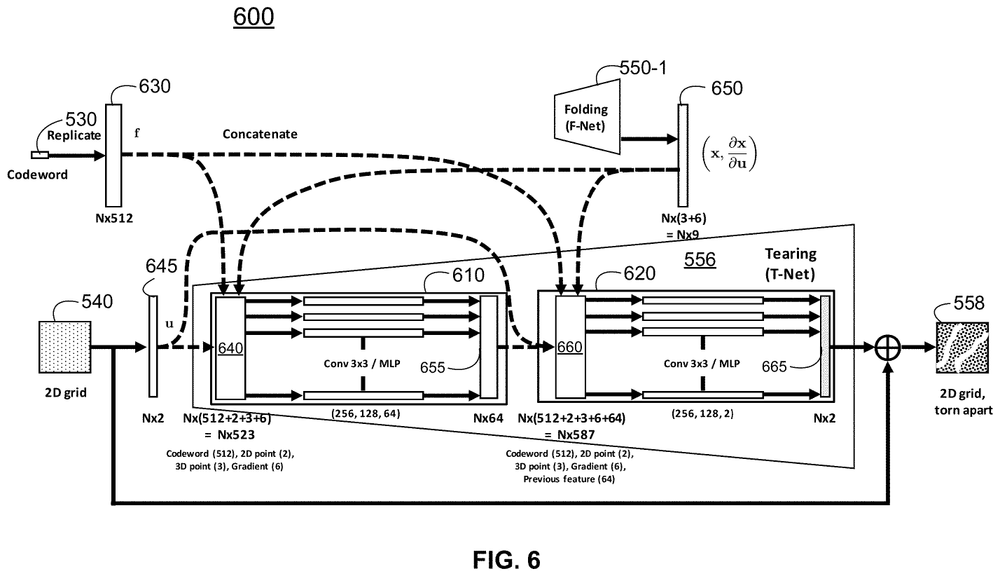

FIG. 9 is a diagram illustrating a representative GCAE 900. Referring to FIG. 9, the GCAE, highlights how to promote topology learning for a general data type as in the TearingNet with multiple iterations. The GCAE 900 may include the same or similar modules as in TearingNet 800, e.g., an encoder E and a decoder D. The decoder D may include a folding module F and a Tearing module T. The output of the encoder E may be a descriptor vector c which may be the input to the decoder D. The output of the decoder D may include the reconstructed data representation \hat{X}(e.g., a reconstructed PC, a reconstructed video, a reconstructed image and/or a reconstructed audio) and an evolved grid u that may indicate the topology of the input data representation. The GCAE 900 may promote the utilization of topology in signals in an autoencoder implementation/design. The GCAE architecture/design may be applied to any signals (e.g., data representation) for which topology matters in their related applications, for example, image/video coding, image processing, PC processing, and/or data processing, among others.

The GCAE 900 may include the folding module F in a loop structure with the Tearing module T. The input to the folding module F may be modified for each iteration. Initially the 2D grid u may be input to the folding module F. In second and further iterations the output Δu is combined (e.g., summed with the initial 2D grid u) to obtain \textcircled{u}, which is input to the folding module F.

Instead of a two-module conventional autoencoder, the GCAE may include a three-module architecture/design that may include an encoder module (e.g., E-Net module (E)), a folding module (e.g., F-Net module (F)) and a tearing module (e.g., T-Net module (T)). A graph with a certain initialization, as shown in the various FIGs may also be implemented. The graph may explicitly represent the topology of the data representation in the decoding operation (e.g., decoding computation).

In the decoder D of the autoencoder of FIG. 9, the F-Net module and the T-Net module are interfaced (e.g., talk to each other in an iterative manner). During interactions, the F-Net module may embed a graph topology into a reconstructed signal. For example, if a signal (e.g., an image, or a PC) is sampled in the spatial domain, the topology may be implicitly represented by the relationship of the sampling points (the pixels and/or points). The T-Net module may extract the implicit topology from the reconstructed signal and may represent the topology in a graph domain. The output of the T-Net module (e.g., the direct output of the T-Net module) may be selected as a modification to the original graph to make the training easier to converge for optimal configurations.

In an actual system, the number of iterations may be signaled, definite or pre-determined and the graph topology is contemplated to evolve with each of the iterations.

TearingNet for a PC autoencoder disclosed herein is an example of a GCAE and one of skill in the art understands from TearingNet how a GCAE may be utilized for learning a topology-friendly representation for a signal (e.g., data representation) such as for PCs. A GCAE may provide a benefit (e.g., a clear benefit) when the PCs are for objects with high genus or for scenes with multiple objects.

### Representative Design/Architecture of the T-Net Module

The T-Net module can be implemented in a number of different ways including the use of an MLP network, as the building block. With an MLP implementation, the gradient of the output of the F-Net module relative to the graph may be helpful since the gradient provides neighborhood information. In other embodiments, the T-Net module may be implemented with one or more CNNs (e.g., with convolutional neural network layers, as the design/architecture, for example, using a 3×3 convolution kernel). Such a kernel may count context, and may or may not skip the introduction/use of the gradient as input to the T-Net module.

### Representative GCAE Procedures for Human Action Recognition

A human skeleton is able to be detected in various ways. It is often used for human action recognition. An autoencoder may be considered for the task of human action recognition. An input signal may be a sequence of the 2D (or 3D) coordinates of the human skeleton, it is contemplated that the codeword from the E-Net module may be used for action recognition, and the GCAE decoder (which includes the F-Net module) and the T-Net module may reconstruct the human skeleton from the codeword. For example, in certain embodiments, for this task, the initial graph topology may be selected according to joint connections of a human body. Graph weights on the connections may be updated from the output of the T-Net module. The F-Net module may be implemented/designed in a way that takes the graph as input and predict the coordinates of the skeleton joint positions. As the skeleton graph involves a rather small number of points (joints), the graph input to F-Net module can be arranged as an adjacency matrix of the graph. It is contemplated that both the F-Net module and the T-Net module may also take the codeword as input in addition to the graph. For brevity, the codeword processing will not be reviewed in detail. The focus will be on the context of the topology. A loss function may be defined as a mean square error between input data representation for skeleton and output data representation for the skeleton. For example, the errors in each joint may be computed and then a mean square error may be calculated.

### Representative GCAE Procedures for Image Search and Retrieval

For image search and retrieval applications, it may be useful/needed to identify communities among an image dataset. In image search and retrieval applications, an image dataset may be taken as the context. To apply GCAE, an image may be input to the E-Net module to output a codeword. The decoder may initialize a graph that represent the similarity of the input image to other images in the dataset. The F-Net module may predict a score of similarity of the input image to each image in the image dataset. The T-Net module may take the prediction scores as input and may update the graph such that the graph may better predict the similarity topology. In the end, the loss function may be defined as the image similarity between the input image and an image with the highest score. The graph topology over the image dataset is actually an asset (e.g., an important asset) for the search and retrieval application. Using GCAE, such topology can be constructed and refined. Therefore, the graph topology may be an output of the GCAE decoder after performing queries within an image dataset.

### Representative GCAE Procedures for Image Analysis

For image analysis applications, topology in an image is an asset (e.g., key asset). How to extract an image representative description may be the target of the application. A GCAE design/architecture may be implemented to learn a representation for the image search. The E-Net module may take an image as the input; and may generate a latent codeword for the image. The E-Net module may choose a known image feature extractor, e.g., AlexNet, ResNet, etc. The decoder design/architecture, via the end-to-end training, may drive/modify the encoder's output (e.g., via the setting of the neural network weights during training). The graph may be initialized as a 2D grid, because the image pixels are organized in 2D. Graph edges may be constructed between (e.g., only between) neighboring pixels with a constant weight. The F-Net module may take the graph, as input, in addition to the codeword and may generate an image, as the output. The T-Net module may estimate a graph modification from the output image.

A loss function between the input image and the output image may be computed based on a mean square error (MSE) or another distance-based error function. Resampling is assumed to align the input resolution and the output resolution to facilitate the computation of the MSE.

### Representative GCAE Procedures for Image Coding

Similar to image search and retrieval application, for image coding, identification of similar image patches to remove redundancies is useful/needed. A GCAE may be adapted to facilitate block-based image coding, in which images may be partitioned into blocks for coding/compression (e.g., coding/compression purposes). In addition to embodiments that are similar to those for Image Analysis, a different graph topology may be selected to be learned. For example, a 1D graph (e.g., a line graph) may be applied, as image blocks for coding tiny pictures. For example, imaging (e.g., image coding) of tiny pictures may be completed using a single stroke. The loss function may be defined the same way as set forth earlier herein.

### Representative GCAE Procedures for Video Coding

Compared to image coding, video coding is different, for example due to inter-frame predictions, which introduces a 3^{rd} dimension (e.g., a temporal direction). For certain embodiments, the evolving topology generated by the iterations in the GCAE decoder may be used to code the motion field between image frames. It is contemplated to treat a group of frames and/or a group of pictures (GOP) within one framework. For example, the input to the video coding GCAE may be a GOP. Each iteration of the GCAE decoder may output a frame in the GOP. In this example, the graph may be initialized as an image with all pixels being equal to 0. The T-Net module may decode a motion field and the F-Net module may apply the motion field to a previous frame. In certain embodiments, the GOP may be modified to a smaller volume over the temporal direction and this modified GOP may be referred to as a group of blocks (GOB).

### Representative GCAE Procedures for Scene Analysis

The GCAE and/or TearingNet may be used for scene analysis including, for example, object counting and detection. The codewords obtained from the encoder (E-Net) module characterizes the topology of the input scene. For instance, two scenes with similar topologies should have similar codewords. The codewords produced/generated by the GCAE may enable scene analysis tasks such as object counting and/or detection. For example, a classifier may be trained taking as input the codewords and may output the number of objects in the scene. In addition to or in lieu of the classifier output, the torn 2D grid may also be used to perform object counting and/or detection, for example based on detected patches.

### Representative GCAE Procedures for PC Coding

For PC coding, one of skill in the art understands that the examples herein for image coding and/or for video coding apply (e.g., apply in principle). These procedures may be used to code static PCs and/or dynamic PCs.

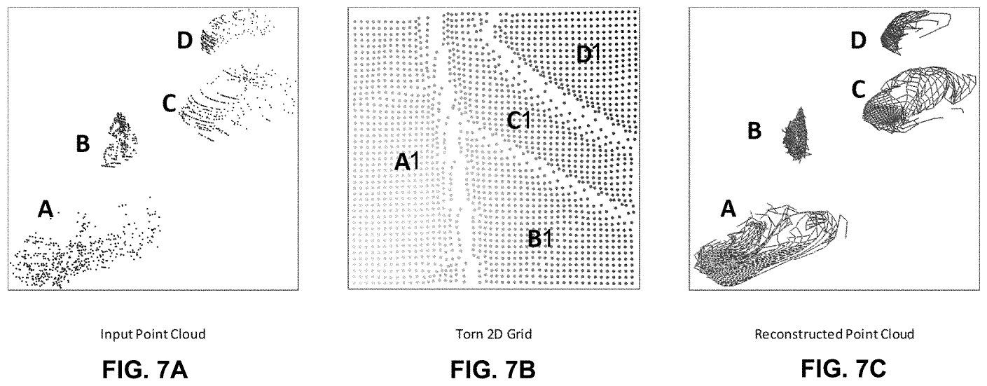

FIG. 10 is a block diagram illustrating a representative method (e.g., implemented by a neural network-based decoder (NNBD)).

Referring to FIG. 10, the representative method 1000 may include, at block 1010, the NNBD obtaining or receiving a codeword, as a descriptor of an input data representation. At block 1020, a first neural network (NN) module of the NNBD may determine based on at least the codeword and an initial graph, a preliminary reconstruction of the input data representation. At block 1030, the NNBD may determine, based on at least the preliminary reconstruction and the codeword, a modified graph. At block 1040, the first NN module may determine, based on at least the codeword and the modified graph, a refined reconstruction of the input data representation. For example, the modified graph may indicate topology information associated with the input data representation.

In certain representative embodiments, the modified graph may be determined by combining the initial graph and an output of a second NN module.

In certain representative embodiments, the modified graph may be a locally connected graph.

In certain representative embodiments, the NNBD may generate a concatenation matrix for processing by one or more Convolutional Neural Networks (CNNs), by concatenating at least: (1) a replicated codeword, (2) the initial graph or the modified graph and (3) the reconstructed data representation. For example, the NNBD may perform a series of convolution layer operations using the generated concatenation matrix. A kernel size for each convolution layer operation may be a (2n+1)×(2n+1) kernel size where n is a non-negative integer.

In certain representative embodiments, the input data representation may be or may include any of: (1) a point cloud, (2) an image, (3) a video, and/or (4) an audio.

In certain representative embodiments, the NNBD may be or may include a Graph Conditioned NNBD.

In certain representative embodiments, the determination of the refined reconstruction of the input data representation may be performed via a plurality of iterative operations of at least the first NN module.

In certain representative embodiments, the NNBD may include any of: one or more Convolutional Neural Networks (CNNs) or one or more Multi-layer Perceptrons (MLPs).

In certain representative embodiments, the NNBD may include one or more Multi-layer Perceptrons (MLPs). For example, the modified graph and/or the refined reconstruction of the data representation may be based on or further based on gradient information generated by the one or more MLPs.

In certain representative embodiments, the NNBD may identify, in accordance with the topology information indicated by the modified graph, any of: (1) one or more objects represented in the input data representation; (2) a number of the objects; (3) an object surface represented in the input data representation; and/or (4) a motion vector associated with an object represented in the input data representation.

In certain representative embodiments, the codeword may be the descriptor vector representing an object or a scene with multiple objects.

In certain representative embodiments, the initial graph and the modified graph may be a 2 dimensional (2D) point set. The input data representation may be a point cloud.

In certain representative embodiments, the determination of the preliminary reconstruction of the input data representation may include the NNBD performing a deforming operation based on the descriptor vector and the 2D point set that is initialized with a pre-determined sampling in a plane.

In certain representative embodiments, the determination of the preliminary reconstruction of the input data representation may include the NNBD generating the preliminary reconstruction of the point cloud.

In certain representative embodiments, the determination of the modified graph may include the NNBD performing a tearing operation, based on the preliminary reconstruction of the point cloud, the descriptor vector and the initial graph to generate the modified graph.

In certain representative embodiments, the NNBD may generate the modified graph, as a locally-connected graph.

In certain representative embodiments, the NNBD may perform graph filtering on the refined reconstruction of the input data representation and/or may output the filtered and refined reconstruction of input data representation, as a final reconstruction of the input data representation.

In certain representative embodiments, the locally-connected graph may be constructed based on: (1) generation of graph edges for nearest neighbors in the initial graph or modified graph; (2) assignment of graph edge weights based on point distances in the modified graph; and/or (3) pruning of graph edges with graph weights smaller than a threshold.

In certain representative embodiments, the performance of the graph filtering on the refined reconstruction of the input data representation may include generation of a smoothed and reconstructed input data representation such that the final reconstruction of the input data representation is smoothed in a graph domain.

In certain representative embodiments, the NNBD may set neural network weights in the NNBD in accordance with a two stage training operation. For example, in the first stage of the two stage training operation, the first NN module may be trained with the superset-distance included in a first stage loss function; and in the second stage of the two stage training operation, the first NN module and the second NN module may be trained with a Chamfer distance included in a second stage loss function based on a subset-distance and the superset-distance.

In certain representative embodiments, the initial graph may be a 2D grid that includes a matrix of points, each point indicating a 2D position. For example, the 2D grid may be associated with a manifold, each point indicating a fixed position on the manifold and/or the 2D grid may be a fixed set of sampled points from a 2D plane.

In certain representative embodiments, the determination of the modified graph may include any of: (1) replication of the received or obtained codeword K times to generate a K×D codeword matrix, wherein K is a number of nodes in the initial graph and D is a length of the codeword, (2) concatenation of the K×D codeword matrix and the initial graph, as a K×N matrix, to generate a K×(D+N) concatenated matrix; (3) input of the concatenated matrix to one or more CNNs and/or MLPs; (4) generation, by the one or more CNNs or MLPs from the concatenated matrix, of the modified graph; and/or (5) update of the refined reconstruction of the input data representation based on the modified graph to generate a final reconstruction of the input data representation.

In certain representative embodiments, the NNBD may concatenate the codeword matrix to the output of a first set of CNN or MLP layers, as a concatenated intermediary matrix; and/or may input, the concatenated intermediary matrix to a next set of CNN or MLP layers following the first set of CNN or MLP layers.

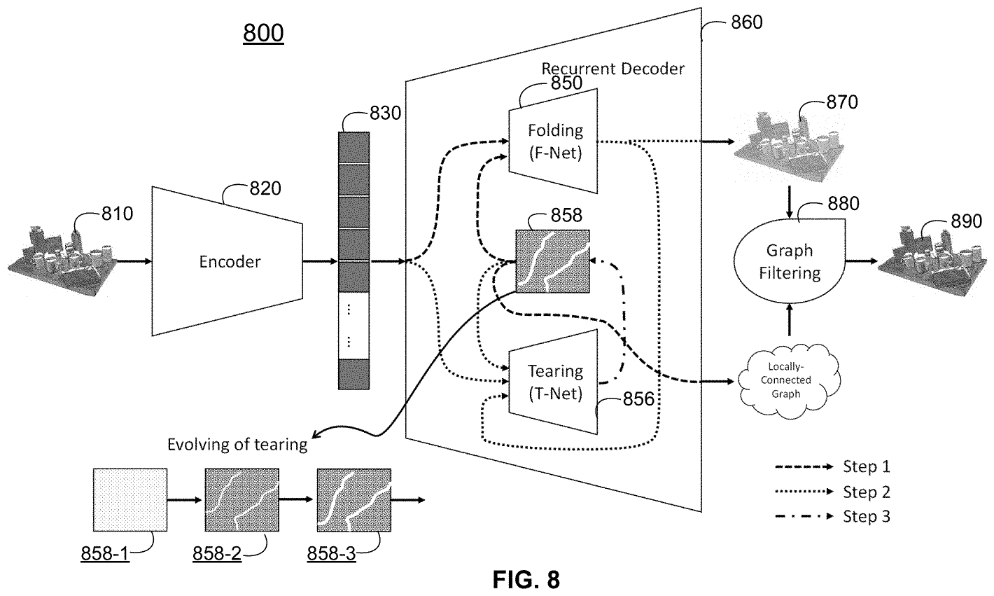

FIG. 11 is a block diagram illustrating a representative training method using a multi-stage training operation.

Referring to FIG. 11, the representative method 1100 may include, at block 1110, in a first stage of the multi-stage training operation, a first NN (e.g., a first NN module) being trained using a first loss function. At block 1120, in a second stage of the multi-stage training operation, the first NN (e.g., the first NN module) and a second NN (e.g., a second NN module), interfaced to the first NN, may be trained using a second loss function. For example, the first loss function may be based on a superset-distance and the second loss function may be based on a subset-distance and the superset-distance. In certain examples, the first NN may include a folding module and the second NN may include a tearing module.

In certain representative embodiments, in the first stage of the multi-stage training operation, the training may include iteratively determining values of parameters associated with nodes in the first NN that satisfy a first loss condition associated with a difference between an input data representation and a reconstructed input data representation; and/or in the second stage of the multi-stage training operation, the training may include iteratively determining the values of parameters associated with nodes in the first and second NNs that satisfy a second loss condition associated with a difference between the input data representation and the reconstructed input data representation. For example, the determined values associated with the nodes in the first NN in the first stage of the multi-stage training operation may be values initially used for the nodes of the first NN in the second stage of the multi-stage training operation.

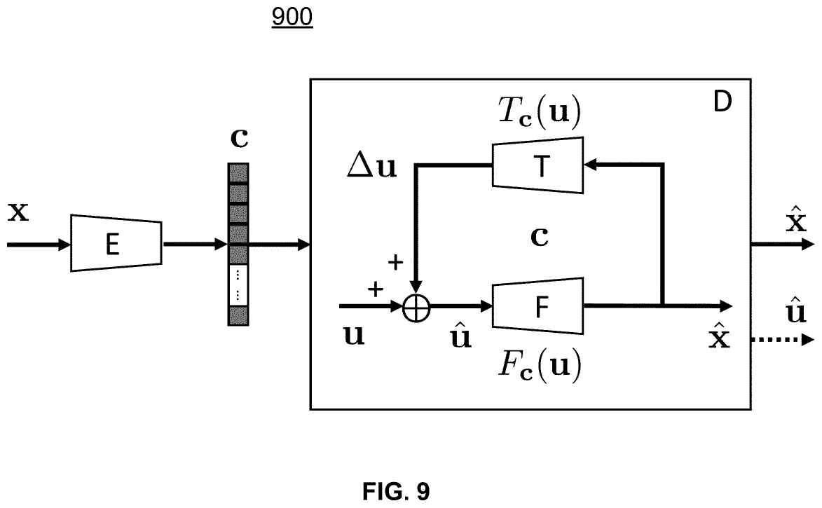

FIG. 12 is a block diagram illustrating another representative method (e.g., implemented by a NNBD).

Referring to FIG. 12, the representative method 1200 may include, at block 1210, the NNBD obtaining or receiving a codeword, as a descriptor of an input data representation. At block 1220, the NNBD may determine, based on the codeword, a preliminary reconstruction of the input data representation. At block 1230, the NNBD may determine, based on: (1) an initial graph associated with the input data representation, (2) the preliminary reconstruction of the input data representation, and (3) the codeword, a modified graph. The modified graph may indicate topology information associated with the input data representation.

In certain representative embodiments, the modified graph, evolved graph and/or refined and modified graph may be output and used to provide topology information associated with the input data representation.

In certain representative embodiments, the NNBD may identify, in accordance with the topology information indicated by the modified graph, any of: (1) one or more objects represented in the input data representation; (2) a number of the objects; (3) an object surface represented in the input data representation; and/or (4) a motion vector of an object represented in the input data representation.

In certain representative embodiments, the NNBD may determine, based on the codeword and the modified graph, a refined reconstruction of the input data representation and/or may determine, based on: (1) the modified graph, (2) the refined reconstruction of the input data representation, and (3) the codeword, a refined modified graph, wherein the refined modified graph may indicate refined topology information associated with the input data representation.

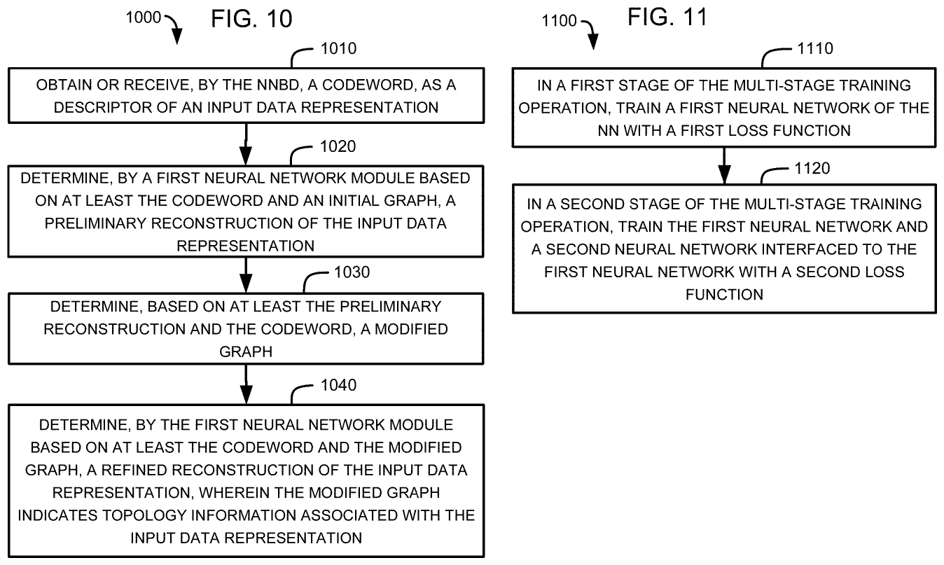

FIG. 13 is a block diagram illustrating a further representative method (e.g., implemented by a neural network-based autoencoder (NNBAE), for example including an encoding network (E-Net) module and a neural network-based decoder (NNBD).

Referring to FIG. 13, the representative method 1300 may include, at block 1310, the E-Net module of the NNBAE determining, based on an input data representation, a codeword, as a descriptor of an input data representation. At block 1320, the F-Net/folding module of the NNBAE may determine, based on at least the codeword and an initial graph with K points, a preliminary reconstruction of the input data representation. At block 1330, the T-Net/tearing module of the NNBD may determine, based on at least the codeword and the initial graph, a modified N graph evolved from the initial graph. At block 1340, the F-Net module of the NNBD may determine, based on at least the codeword and the modified graph, a refined reconstruction of the input data representation. The modified graph may indicate topology information associated with the input data representation, and the E-Net module may be jointly trained with the NNBD.

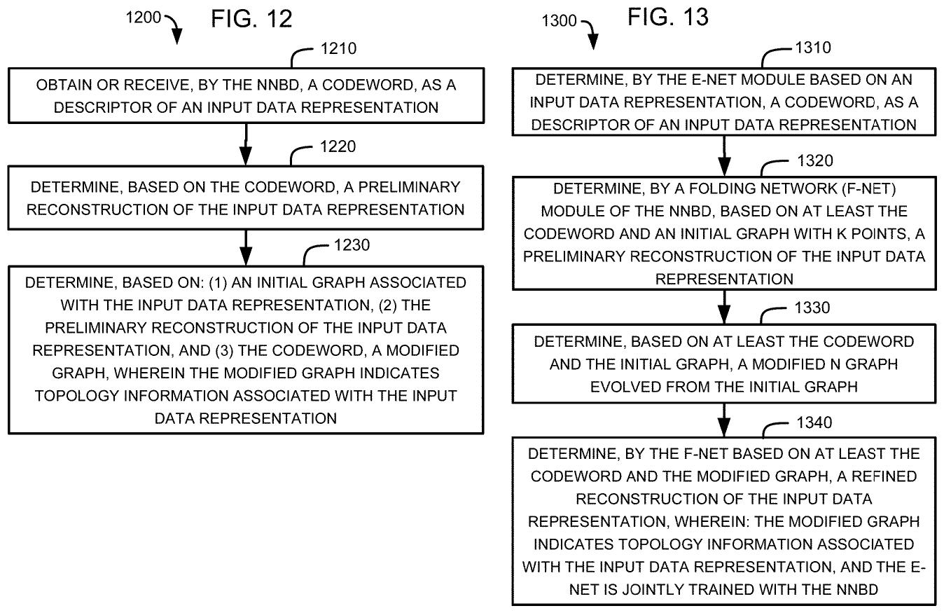

FIG. 14 is a block diagram illustrating an additional representative method (e.g., implemented by a NNBD).

Referring to FIG. 14, the representative method 1400 may include, at block 1410, the NNBD obtaining or receiving a codeword, as a descriptor of an input data representation. At block 1420, a first NN and/or folding network (F-Net) module may determine based on at least the codeword and a N dimension point set with K points, where N is an integer, a preliminary reconstruction of the input data representation. At block 1430, the NNBD may determine, based on at least the codeword and the N dimensional point set, a modified N dimensional point set evolved from the N dimensional point set. At block 1440, the first NN and/or the F-Net module may determine, based on at least the codeword and the modified N dimensional point set, a refined reconstruction of the input data representation. The modified N dimensional point set may indicate topology information associated with the input data representation.

In certain representative embodiments, a second NN and/or a tearing network (T-Net) module, based on at least the codeword and the N dimensional point set, may determine a modification to the N dimensional point set. The determination of the modified N dimensional point set may include combining a M dimensional point set with the modification to the N dimensional point set to generate the modified N dimensional point set.

In certain representative embodiments, the determination of the modification to the N dimensional point set may include any of: (1) concatenation of a replicated codeword and the N dimensional point set, as a concatenated matrix; (2) input of the concatenated matrix to one or more CNNs; (3) generation, by the one or more CNNs from the concatenated matrix, of a second point set in M dimensional feature space; (4) concatenation of the replicated codeword, the N dimensional point set, and the second point set as a second concatenated matrix; and/or (5) generation, by the one or more CNNs from the second concatenated matrix, of the modification to the N dimensional point set.

In certain representative embodiments, the NNBD may perform a series of convolution layer operations on the concatenated matrix using one or more NNs to generate the modified N dimensional point set and a kernel size for each convolution layer operation may be any of: (1) 1×1 kernel size, (2) 3×3 kernel size and/or (3) 5×5 kernel size etc., among others.

In certain representative embodiments, the input data representation may be or may include any of: (1) a point cloud, (2) an image, (3) a video, or (4) an audio.

In certain representative embodiments, N is equal to 2; and the input data representation may be or may include a point cloud.

In certain representative embodiments, the NNBD may be or includes a Graph Conditioned NNBD.

In some examples, the determination of the refined reconstruction of the input data representation may be performed via an iterative operation of at least the F-Net module.

In certain representative embodiments, the NNBD may include any of: one or more CNNs and/or one or more MLPs.

In certain representative embodiments, the NNBD may include one or more MLPs. For example, the modified N dimensional point set may be further based on gradient information generated by the one or more MLPs.

In certain representative embodiments, the NNBD may identify one or more objects represented in the input data representation in accordance with the topology information indicated by the modified N dimensional point set. For example, the NNBD or another device may use the topology information to identify one or more objects in an input data representation, and/or identify a number of objects represented in the input data representation in accordance with the topology information indicated by the modified N dimensional point set.

As another example, the NNBD or another device may identify an object surface represented in the input data representation in accordance with the topology information indicated by the modified N dimensional point set.

In certain representative embodiments, the NNBD may determine, from the modified N dimensional point set, patches that identify different topological regions of the input data representation.

In certain representative embodiments, the codeword may be or may include a descriptor vector representing an object or a scene with multiple objects.

In certain representative embodiments, the N dimensional point set may be or may include a 2D point set. For example, the input data representation may be or may include a point cloud and/or the determination of the preliminary reconstruction of the input data representation may include performance of a deforming operation based on the descriptor vector and the 2D point set that is initialized with a pre-determined sampling in a plane.

In certain representative embodiments, the determination of the preliminary reconstruction of the input data representation may include generation of the preliminary reconstruction of the point cloud.

In certain representative embodiments, the determination of the modified N dimensional point set evolved from the 2D point set may include: performance of a tearing operation, based on the preliminary reconstruction of the point cloud, the descriptor vector and the 2D point set; and/or generation of the modified N dimensional point set, as a modified 2D point set, from the 2D point set.

In certain representative embodiments, the NNBD may generate a locally-connected graph based on the 2D point set and the modified 2D point set.

In certain representative embodiments, the NNBD or another device (e.g., such as a graph filter) may construct/implement graph filtering (e.g., may perform graph filtering using a generated graph filter on the refined reconstruction of the point cloud from the F-Net module, and/or may output the filtered and refined reconstruction of the point cloud).

In certain representative embodiments, the locally-connected graph may be constructed based on: (1) generation of graph edges for nearest neighbors in the 2D point set; (2) assignment of graph edge weight based on point distances in the modified 2D point set; and/or pruning of graph edges with graph weights smaller than a threshold.

In certain representative embodiments, the performance of the graph filtering on the refined reconstruction of the point cloud may include generation of a smoothed and reconstructed refined point cloud such that the refined, reconstructed point cloud may be smoothed in a graph domain.

In certain representative embodiments, the NNBD may set neural network weights in the NNBD in accordance with a two stage training operation. For example, in the first stage of the two stage training operation, the F-Net module may be trained using a superset-distance, as a loss function and/or in the second stage of the two stage training operation, the F-Net module and the T-Net module may be trained using a Chamfer distance, as the loss function based the superset-distance and a subset-distance.

In certain representative embodiments, the N dimensional point set may be or may include a 2D grid that includes a matrix of points, each point may indicate a 2D position. For example, the 2D grid may be associated with a manifold, each point may indicate a fixed position on the manifold and/or the 2D grid may be a fixed set of sampled points from a 2D plane, a sphere, or a cubic box surface, as the manifold.

In certain representative embodiments, the NNBD may replicate the received or obtained codeword to generate a codeword matrix of the replicated codewords that may be a size of the 2D grid and/or may concatenate the codeword matrix into a concatenated matrix.

In certain representative embodiments, the determination of the modified N dimensional point set may include any of: concatenation of a K×D matrix from a replicated codeword and a K×N matrix from the N dimensional point set to generate a K×(D+N) concatenated matrix, input of the concatenated matrix to one or more CNNs and/or MLPs; generation, by the one or more CNNs and/or MLPs from the concatenated matrix, of a modification to the N dimensional point set; and/or update of the N dimensional point set based on the modification to generate the modified N dimensional point set.

In certain representative embodiments, the NNBD may any of: (1) concatenate, a K×D matrix from the replicated codeword to the output of a first CNN or MLP layer; and/or (2) input the concatenated matrix to a next CNN or MLP layer following the first CNN or MLP layer.

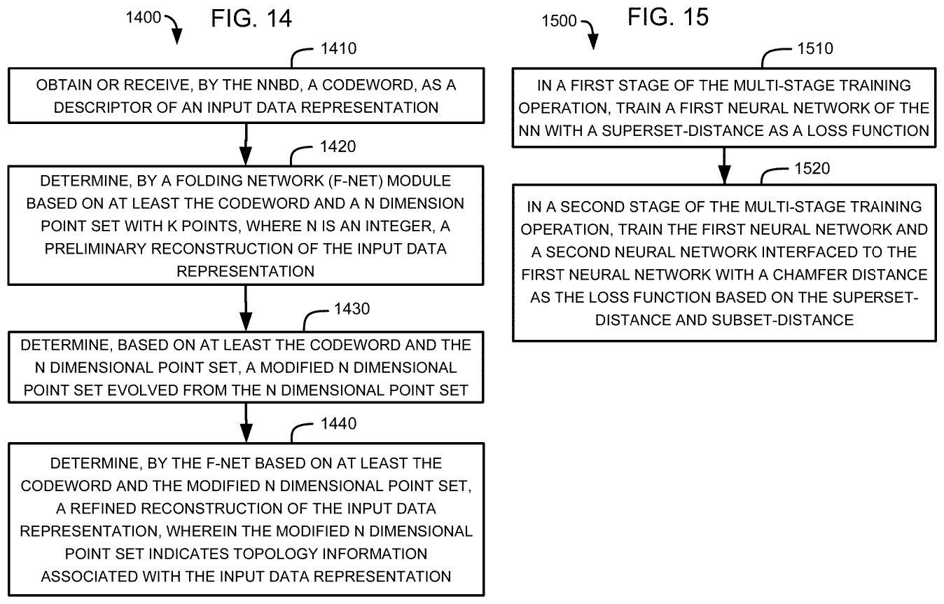

FIG. 15 is a block diagram illustrating a representative training method (e.g., implemented by a neural network (NN)) using a multi-stage training operation.

Referring to FIG. 15, the representative method 1500 may include, at block 1510, in a first stage of the multi-stage training operation, a first neural network of the NN trained using a superset-distance as a loss function. At block 1520, in a second stage of the multi-stage training operation, the first neural network and a second neural network interfaced to the first neural network may be trained using a Chamfer distance, as the loss function based on the superset-distance and a subset-distance.

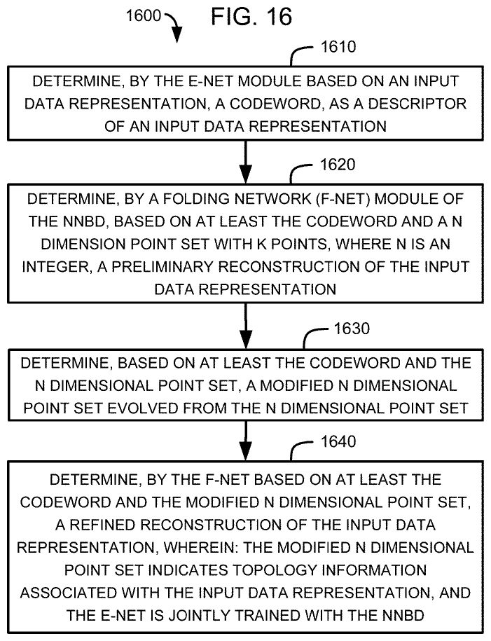

FIG. 16 is a block diagram illustrating a representative training method (e.g., implemented by a NNBAE including an E-Net module and a NNBD.

Referring to FIG. 16, the representative method 1600 may include, at block 1610, determining, by the E-Net module based on an input data representation, a codeword, as a descriptor of an input data representation. At block 1620, an F-Net module of the NNBD may determine, based on at least the codeword and a N dimension point set with K points, where N is an integer, a preliminary reconstruction of the input data representation. At block 1630, the NNBD may determine, based on at least the codeword and the N dimensional point set, a modified N dimensional point set evolved from the N dimensional point set. At block 1640 the F-Net module, based on at least the codeword and the modified N dimensional point set, may determine a refined reconstruction of the input data representation. For example, the modified N dimensional point set may indicate topology information associated with the input data representation and/or the E-Net may be jointly trained with the NNBD.

In certain representative embodiments, the NNBD or another device may identify one or more objects represented in the input data representation in accordance with the topology information embedded in the topology-friendly codeword.

In certain representative embodiments, the NNBD or another device may identify a number of objects represented in the input data representation in accordance with the topology information embedded in the topology-friendly codeword.

In certain representative embodiments, a tearing network (T-Net) module may determine, based on at least the codeword and the N dimensional point set, a modification to the N dimensional point set. For example, the determination of the modified N dimensional point set may include combining a M dimensional point set with the modification to the N dimensional point set to generate the modified N dimensional point set.

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The hardware (e.g., a processor, GPU, or other hardware) and appropriate software may implement one or more neural networks having various architectures such as a perception neural network architecture, a feed forward neural network architecture, a radial basis network architecture, a deep feed forward neural network architecture, a recurrent neural network architecture, a long/short term memory neural network architecture, a gated recurrent unit neural network architecture, an autoencoder (AE) neural network architecture, a variation AE neural network architecture, a denoising AE neural network architecture, a sparse AE neural network architecture, a Markov chain neural network architecture, a Hopfield network neural network architecture, a Boltzmann machine (BM) neural network architecture, a restricted BM neural network architecture, a deep belief network neural network architecture, a deep convolutional network neural network architecture, a deconvolutional network architecture, a deep convolutional inverse graphics network k architecture, a generative adversarial network architecture, a liquid state machine neural network architecture, an extreme learning machine neural network architecture, an echo state network architecture, a deep residual network architecture, a Kohonen network architecture, a support vector machine neural network architecture, and a neural turning machine neural network architecture, among others. Each cell in the various architectures may be implemented as a backfed cell, an input cell, a noisy input cell a hidden cell, a probabilistic hidden cell, a spiking hidden cell, an output cell, a match input output cell, a recurrent cell, a memory cell, a different memory cell, a kernel cell or a convolution/pool cell. Subsets of the cells of a neural network may form a plurality of layers. These neural networks may be manually trained or through an automated training process.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented by a neural network-based decoder (NNBD), comprising:
obtaining or receiving, by the NNBD, a codeword, as a descriptor of an input data representation;
determining, by a first neural network module based on at least the codeword and an initial graph, a preliminary reconstruction of the input data representation;
determining, by a second neural network module based on at least the preliminary reconstruction and the codeword, a modified graph; and
determining, by the first neural network module based on at least the codeword and the modified graph, a refined reconstruction of the input data representation,
wherein the modified graph indicates topology information associated with the input data representation.

2. The method of claim 1, wherein the modified graph is determined by combining the initial graph and an output of the second neural network module.

3. The method of claim 1, wherein the modified graph is a locally connected graph.

4. The method of claim 1, further comprising generating a concatenation matrix for processing by one or more Convolutional Neural Networks (CNNs), by concatenating at least a replicated codeword, the initial graph or the modified graph and the reconstructed data representation.

5-6. (canceled)

7. The method of claim 1, wherein:
the NNBD is a Graph Conditioned NNBD; and
the determining of the refined reconstruction of the input data representation is performed via a plurality of iterative operations of at least the first neural network module.

8. (canceled)

9. The method of claim 1, wherein:
the NNBD includes one or more Multi-layer Perceptrons (MLPs); and
the modified graph and the refined reconstruction of the data representation is further based on gradient information generated by the one or more MLPs.

10-11. (canceled)

12. The method of claim 1, wherein:
the initial graph and the modified graph are 2 dimensional (2D) point set;
the input data representation is a point cloud; and
the determining of the preliminary reconstruction of the input data representation includes performing a deforming operation based on the descriptor vector and the 2D point set that is initialized with a pre-determined sampling in a plane.

13. (canceled)

14. The method of claim 1, wherein the determining of the modified graph includes:
performing a tearing operation, based on the preliminary reconstruction of the input data representation, the descriptor vector and the initial graph to generate the modified graph.

15-20. (canceled)

21. The method of claim 1, wherein the determining of the modified graph includes:
replicating the received or obtained codeword K times to generate a K×D codeword matrix, wherein K is a number of nodes in the initial graph and D is a length of the codeword;
concatenating, the K×D codeword matrix and the initial graph, as a K×N matrix, to generate a K×(D+N) concatenated matrix;
inputting, the concatenated matrix to one or more Convolutional Neural Networks (CNNs) or Multi-layer Perceptrons (MLPs);
generating, by the one or more CNNs or MLPs from the concatenated matrix, the modified graph; and
updating the refined reconstruction of the input data representation based on the modified graph to generate a final reconstruction of the input data representation.

22. The method of claim 21, further comprising:
concatenating the codeword matrix to the output of a first set of CNN or MLP layers, as a concatenated intermediary matrix; and
inputting, the concatenated intermediary matrix to a next set of CNN or MLP layers following the first set of CNN or MLP layers.

23. A neural network-based decoder (NNBD), comprising:
a receiver unit configured to receive or obtain a codeword, as a descriptor of an input data representation;
a first neural network (NN) module configured to: determine, based on at least the codeword and an initial graph, a preliminary reconstruction of the input data representation; and
a second NN module configured to determine, based on at least the preliminary reconstruction and the codeword, a modified graph, wherein:
the first NN module is further configured to determine, based on at least the codeword and the modified graph, a refined reconstruction of the input data representation, and the modified graph indicates topology information associated with the input data representation.

24. The NNBD of claim 23, wherein the modified graph is a locally connected graph.

25. The NNBD of claim 23, wherein:
the second NN module includes one or more Convolutional Neural Networks (CNNs);
the NNBD is configured to generate a concatenation matrix using at least (1) a replicated codeword, (2) the initial graph or the modified graph and (3) the reconstructed data representation; and
the one or more CNNs are configured to process the concatenation matrix and to generate the modified graph or a refined modified graph.

26-27. (canceled)

28. The NNBD of claim 23, wherein:
the NNBD is a Graph Conditioned NNBD; and
the first NN module is configured to perform a plurality of iterative operations.

29. (canceled)

30. The NNBD of claim 23, wherein:
the first NN module includes one or more Multi-layer Perceptrons (MLPs) configured to generate gradient information; and
the second NN module is configured to output the modified graph based on the gradient information generated by the one or more MLPs.

31-32. (canceled)

33. The NNBD of claim 23, wherein:
the initial graph and the modified graph are 2 dimensional (2D) point set;
the input data representation is a point cloud, and
the first NN module is configured to perform a deforming operation based on the descriptor vector and the 2D point set that is initialized with a pre-determined sampling in a plane.

34. (canceled)

35. The NNBD of claim 33, wherein the second NN module is configured to perform a tearing operation, based on the preliminary reconstruction of the input data representation, the descriptor vector and the initial graph to generate the modified graph.

36-40. (canceled)

41. The NNBD of claim 23, wherein:
the initial graph is a 2D grid that includes a matrix of points, each point indicating a 2D position;
the 2D grid is associated with a manifold, each point indicating a fixed position on the manifold; and
the 2D grid is a fixed set of sampled points from a 2D plane.

42. The NNBD of claim 41, wherein the NNBD is configured to:
replicate the received or obtained codeword K times to generate a K×D codeword matrix, wherein K is a number of nodes in the initial graph and D is a length of the codeword;
concatenate, the K×D codeword matrix and the initial graph, as a K×N matrix, to generate a K×(D+N) concatenated matrix;
input, the concatenated matrix to one or more Convolutional Neural Networks (CNNs) or Multi-layer Perceptrons (MLPs) of the NNBD;
generate, by the one or more CNNs or MLPs of the NNBD from the concatenated matrix, the modified graph; and
update the refined reconstruction of the input data representation based on the modified graph to generate a final reconstruction of the input data representation.

43. The NNBD of claim 42, wherein the NNBD is configured to:
concatenate the codeword matrix to the output of a first set of CNN or MLP layers, as a concatenated intermediary matrix; and
input, the concatenated intermediary matrix to a next set of CNN or MLP layers following the first set of CNN or MLP layers.
